(19) United States
(12) Patent Application Publication
(10) Pub. No.: US 2024/0364419 A1
(43) Pub. Date: Oct. 31, 2024

(54) Reconfigurable Software-Defined Optical Time-Domain Reflectometer for Diagnostics and Sensing

(71) Applicant: The Government of the United States of America, as represented by the Secretary of the Navy, Arlington, VA (US)

(72) Inventors: Tao Wei, West Kingston, RI (US); Thomas Mauldin, New London, CT (US); Zhenyu Xu, Kingston, RI (US)

(21) Appl. No.: 18/403,674

(22) Filed: Jan. 3, 2024

Related U.S. Application Data
(60) Provisional application No. 63/436,716, filed on Jan. 3, 2023.

(51) Int. Cl. H04B 10/071; H04B 10/50

(52) U.S. Cl. CPC H04B 10/071; H04B 10/503

(57) ABSTRACT

Systems and methods are provided for a software defined optical time-domain reflectometer (SD-OTDR) using high-speed optical transceiver modules. Enabled by the reconfigurable computing resource, an SD-OTDR in accordance with an embodiment of the present disclosure can realize in-situ diagnostics of optical fiber without adding any overhead to existing systems. In addition, an SD-OTDR in accordance with an embodiment of the present disclosure can also be used for high-resolution distributed sensing. Additionally, an SD-OTDR in accordance with an embodiment of the present disclosure can directly map optical reflections at different locations along the length of a fiber to a processing element array in a Field-Programmable Gate Array for real-time in-sensor parallel data processing.

### CROSS REFERENCE TO RELATED APPLICATIONS

This application claims the benefit of U.S. Provisional Patent Application No. 63/436,716, filed on Jan. 3, 2023, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; techtran@nrl.navy.mil, referencing Navy Case Number 81100864

### FIELD OF THE DISCLOSURE

This disclosure relates to communications, including optical communications.

### BACKGROUND

There has been a lot of growth in high-speed transceivers offered by System-on-Chip (SoC) platforms to meet the ever-growing demand for high data rates in modern society. A benefit of these SoCs is that they typically contain field-programmable gate array (FPGA) fabric. Not only are the data rates of these transceivers increasing, but they are also improving in terms of power consumption, cost, latency, and jitter.

One industry that is particularly taking advantage of this growth is for optical communications. In this case, the transceivers are commonly connected to standardized small form-factor pluggable (SFP) modules, which come in many different form-factors; namely, SFP, SFP+, SFP28, SFP56, and QSFP. This progression of the SFP technology demonstrates how the data rates are continuously advancing. Data rates beyond 25 Gb/s are realized through PAM4 modulation schemes, parallel transmission, and/or wavelength division multiplexing. Furthermore, they are optimized to achieve a low overhead while meeting industrial demands.

A problem can arise with SFP modules when there is a faulty fiber used to guide the light carrying the information from one transceiver to another. An unexpected reduction in the optical power can lead to dropped bits, resulting in lost information. This loss may be difficult to detect without using an optical reflectometer, which can be realized in the form of an optical time-domain reflectometer (OTDR). Standalone equipment is used for OTDR measurement. Standalone OTDR equipment requires technician to connect the machine into a fiberoptic system for measurement. It is associated with high cost and long system down time. High resolution distributed fiber sensing is typically at a very high cost (e.g., around $100,000).

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a diagram of an exemplary software defined optical time-domain reflectometer (SD-OTDR) system in accordance with an embodiment of the present disclosure;

FIG. 2 is a diagram of an exemplary System-on-Chip (SoC) in accordance with an embodiment of the present disclosure;

FIG. 3 is a flowchart showing the various steps throughout an exemplary measuring procedure in accordance with an embodiment of the present disclosure;

FIG. 4 is a diagram of an in-sensor parallel data processing array 210 in accordance with an embodiment of the present disclosure;

FIG. 5 is a diagram showing an exemplary SD-OTDR measurement in accordance with an embodiment of the present disclosure;

FIG. 6 is a diagram of an exemplary SD-OTDR measurement with an optical amplifier in accordance with an embodiment of the present disclosure;

FIG. 7 is a diagram of a bi-directional full duplex passive optical network cabling in accordance with an embodiment of the present disclosure;

FIG. 8 is a diagram illustrating direct-detection phase-OTDR theory in accordance with an embodiment of the present disclosure;

FIG. 9 is a diagram illustrating an exemplary structure of a lookup table in accordance with an embodiment of the present disclosure;

FIG. 10 is a diagram showing an exemplary OTDR system in accordance with an embodiment of the present disclosure;

FIG. 11 is a block diagram of an exemplary SoC design in accordance with an embodiment of the present disclosure;

FIG. 12 is a block diagram illustrating an exemplary in-sensor parallel data processing module in accordance with an embodiment of the present disclosure;

FIG. 13A is a diagram illustrating an exemplary measurement of Young's Modulus for an SMF-28® fiber in accordance with an embodiment of the present disclosure;

FIG. 13B is another diagram illustrating an exemplary measurement of Young's Modulus for an SMF-28® fiber in accordance with an embodiment of the present disclosure;

FIG. 13C is a diagram illustrating an exemplary measurement of Young's Modulus for a LEAF® fiber in accordance with an embodiment of the present disclosure;

FIG. 14 is a diagram illustrating an exemplary breakdown of the sensing fiber used in the temperature sensing experiments in accordance with an embodiment of the present disclosure;

FIG. 15 is a diagram illustrating exemplary experimental results for temperature sensing in accordance with an embodiment of the present disclosure;

FIG. 16 is a diagram illustrating a Young's Modulus measurement without an EDFA in accordance with an embodiment of the present disclosure; and

FIG. 17 is a diagram illustrating experimental results with a spatial resolution algorithm to remove outliers in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. OVERVIEW

Embodiments of the present disclosure demonstrate that the readily available, widely deployed, and commercialized high-speed optical transceiver modules can be converted into a state-of-the art software defined optical time-domain reflectometer (SD-OTDR). Enabled by the reconfigurable computing resource, an SD-OTDR in accordance with an embodiment of the present disclosure can realize in-situ diagnostics of optical fiber without adding any overhead to existing systems. In addition, SD-OTDR can also be used for high-resolution distributed sensing.

OTDR is a widely used technology to diagnose optical fiber cables. It detects anomalies such as kink, bending, bad connection along a fiber, as well as provides the location of these anomalies. A software-defined reflectometer in accordance with an embodiment of the present disclosure can obtain sub-cm spatial resolutions with a measurement sensitivity on the order of ˜65 dB. This is made possible by using the advantages offered by the reconfigurable fabric in modern System-on-Chip platforms often found in communication networks. In addition, SD-OTDR in accordance with an embodiment of the present disclosure can be used for distributed sensing with cm-level spatial resolution. The build cost of such a sensing system is expected to be less than $1,000, which is a small fraction of the current comparable devices on the market.

Enabled by the reconfigurable computing resource, SD-OTDR in accordance with an embodiment of the present disclosure can realize in-situ diagnostics of optical fiber without adding any overhead to existing systems. In a nutshell, it can leverage existing communication infrastructure and “convert” them into a diagnostic tool or sensor when needed and can configure them back.

### 2. SOFTWARE-DEFINED OPTICAL TIME-DOMAIN REFLECTOMETER

As discussed above, a problem can arise with SFP modules when there is a faulty fiber used to guide the light carrying the information from one transceiver to another. An unexpected reduction in the optical power can lead to dropped bits, resulting in lost information. This loss may be difficult to detect without using an optical reflectometer, which can be realized in the form of an optical low-coherence reflectometer (OLCR), optical frequency-domain reflectometer (OFDR), or optical time-domain reflectometer (OTDR).

OLCRs offer high spatial resolution on the order of tens of micrometers, but they have very limited measurement range. While the OFDR also offers spatial resolution down to tens of micrometers with longer measurement ranges, it is bulky and costly to implement with its interferometric techniques, high coherent sources, and polarization depended optical components. OTDRs have been favored for diagnostic purposes in industry; however, they have limited spatial resolutions as even high resolution OTDRs struggle to obtain spatial resolutions of tens of centimeters. These diagnostic techniques are either realized as a standalone piece of test equipment that must be plugged into a system while its normal operation is halted, or a subsystem that is built into a substation, ultimately adding substantial overhead.

Embodiments of the present disclosure demonstrate that the readily available, widely deployed, and commercialized SFP modules can be converted into a state-of-the-art software defined OTDR (SD-OTDR) using the advantages offered by the reconfigurable fabric in modern SoC platforms. Significantly, the SoC/FPGA that exists in most network switches that interconnect these SFP modules can be utilized to share communication function and diagnostic probing function by swapping the hardware description language (HDL) files. Enabled by the FPGA fabric, this approach provides the most cost-effective and efficient optical fiber diagnostic technique to date; there is no overhead as only the resources that are already in existence in a communication system are used. Uniquely, both high-speed transceivers in SoCs and SFP modules are constantly enhancing.

In an embodiment, the use of small form-factor pluggable modules is expanded from optical communications to software defined optical time-domain reflectometers. A design in accordance with embodiments of the present disclosure is highly reconfigurable, enabling it to be implemented in existing optical communication infrastructures for in-situ diagnostics without additional overhead. The showcased performance far exceeds the capabilities of existing optical time-domain reflectometers used in industry, offering a sub-cm spatial resolution with a sensitivity to detect discontinuities as small as −65 dB.

### 2.1. Optical Time-Domain Reflectometers

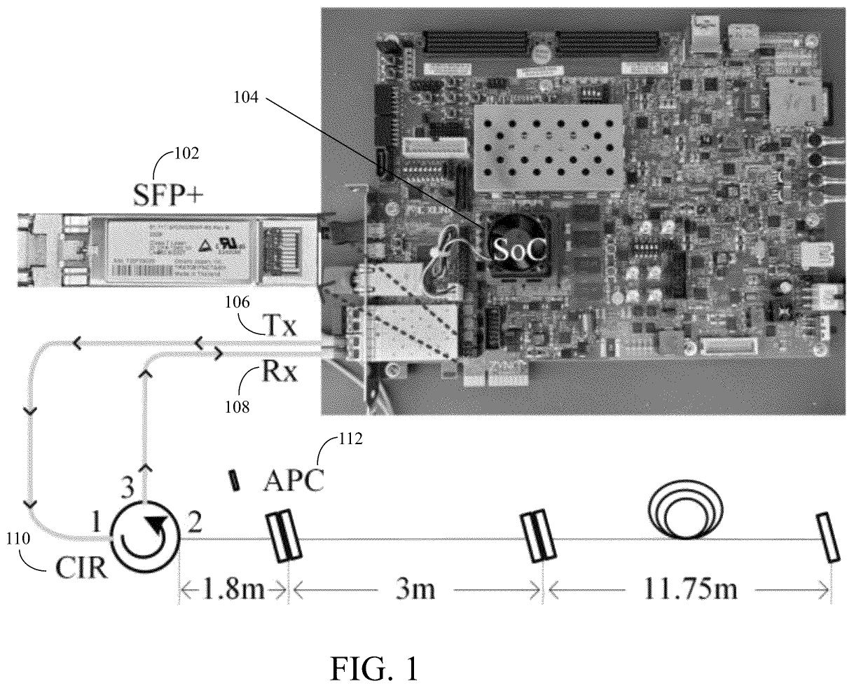

Exemplary working principles of an exemplary OTDR in accordance with an embodiment of the present disclosure will briefly be described. FIG. 1 is a diagram of an exemplary software defined optical time-domain reflectometer (SD-OTDR) system in accordance with an embodiment of the present disclosure. In FIG. 1, a small form-factor pluggable (SFP) module 102 is coupled to a System-on-Chip (SoC) platform 104. The system of FIG. 1 includes a transmitter (Tx) 106, receiver (Rx) 108, circulator (CIR) 110, data converter, and processing system (PS). In FIG. 1, an angled physical connector (APC) 112 is shown coupled to the circulator 110. In FIG. 1, the circulator 110 permits an optical signal to propagate through port 1 to port 2 or port 2 to port 3 while providing high isolation from port 1 to port 3 and port 2 to port 1.

In an embodiment, a test is initiated when the PS triggers the laser source to send an optical probe through the circulator 110 and into a fiber under test (FUT). When there is a discontinuity in refractive index of the fiber's core, a portion of the forward propagating light will be reflected to the source. These discontinuities can come from manufacturing deficiencies, splices, connectors, or ports of other optical components. The reflected light can then be guided into the Rx 108 to convert the light into an electrical signal that can then be read by the PS after it has been converted to digital information. This diagnostic technique uses a time-of-flight measurement to determine the location of a fault, tamper, or defect by taking the propagation velocity of the light in the fiber into account.

### 2.2. Analog-to-Probability Conversion

A major reason OTDRs are not built-in to SFP modules is the requirement for a high-end analog-to-digital converter (ADC) to convert high-bandwidth (>10 GHz) reflections into digital information that can be used to monitor the integrity of an optical fiber with high spatial resolution. The SFP modules contain either a linear amplifier with high gain or a limiting amplifier instead of an ADC because they are used in digital communication systems and only need to worry about whether the signal is a logic high or low. Consequently, the bandwidth of the system is inherently increased, and the cost reduced.

It is possible, however, to use these linear and limiting amplifiers as data converters by exploiting a technique known as analog-to-probability conversion, which is enabled by the FPGA fabric. This reported technique utilizes the fact that the reflections caused by refractive index variations are often on the order of the noise incident on the receiver, which includes thermal, shot, and dark noise. More specifically, if the signal incident on the amplifier is sampled many times, the output of the amplifier will converge to a certain probability of having a logic high output based on the noise distribution. If the incident signal is larger than the worst-case noise, then the amplifier will output a logic high with a probability of 1. The probability that is obtained is therefore proportional to the voltage incident on the amplifier.

The acquired probability can be converted into a corresponding voltage by mapping the probability through the cumulative density function of the noise; however, it is not possible to measure the noise distribution inside an SFP module. Thus, an absolute reflectivity power cannot be determined, and a relative power measurement must be used to determine a severity of a discontinuity.

Another consideration when using an amplifier inside an SFP module as an analog-to-probability converter is the inability to control the hysteresis or limiting amplifier threshold. This reduces the noise that can be exploited during the conversion process. If a programmable hysteresis can be incorporated into SFP modules, it can be changed when updating the bitstream for the FPGA fabric so that the performance of the SD-OTDR can be improved without effecting normal operations. Significantly, this can add very little overhead to the SFPs.

### 2.3. Coded Probes

The second major reason why SFPs are not used for in-situ diagnostics stems from the fact that they are not designed to transmit or receive long strings of consecutive 1's or 0's. As a result, they do not function properly when long strings of consecutive 1's or 0's are present. This means that a single probe cannot be used to interrogate the FUT because the interval between probes is outside the minimum data rate of these high-speed transceivers.

To combat this problem a technique can be used when these long strings of consecutive 1's or 0's are present. That is, the data is encoded. Coded OTDRs have been previously reported to increase the signal-to-noise ratio (SNR) of the measured reflections by having more equivalent energy from the optical probe. They work by encoding a probe into a data pattern using a Hadamard matrix and decoding the reflections that are received. Thus, not only can this technique be adapted to help convert an SFP into an SD-OTDR, but it can also enable smaller reflections to be measured without sacrificing spatial resolution.

A disadvantage is the increased acquisition time. For example, in an embodiment, 1023 simplex codes were used, which increases the acquisition time by 1023; however, by exploiting the parallelism provided by FPGA fabric, these codes can be efficiently implemented and cycled through optimizing the throughput. Furthermore, the SNR enhancement of approximately 12 dB also reduces the number of averages that are required.

### 2.4. Exemplary Systems

In FIG. 1, a Xilinx ZCU106 evaluation board with a Zynq Ultrascale+ XCZU7EV-2FFVC1156 MPSOC was used in place of the SoC one could find in an optical communication link. A 10 Gb/s Oclaro TRS7081FNCTA301 SFP+ module 102 was plugged into the ZCU106 evaluation board. The Tx 106 of the SFP+ module was connected to port 1 of the circulator 110, the FUT was connected to port 2, and the Rx 108 of the SFP+ module 102 was connected to port 3. The FUT includes a single mode optical fiber with two angled physical connector (APC) 112 mattings that have an expected reflectance on the order of −60 to −65 dB and is terminated with an APC-to-air interface with an expected reflectance on the order of −60 dB.

By using the programmable benefits of SoCs deployed in optical links in the field, this system can be added to any system where SFP modules are deployed to add the benefit of in-situ diagnostics. In total, an exemplary implemented design showcased herein requires 56,599 lookup tables (24.57% utilization), 94,418 flip-flops (FFs) (20.49% utilization), 29.5 BRAMs (9.46% utilization), and 1 GTH transceiver (5% utilization). The static on-chip power is estimated to be 735 mW and the dynamic on-chip power is estimated to be 3.465 W giving a total estimated on-chip power of 4.198 W.

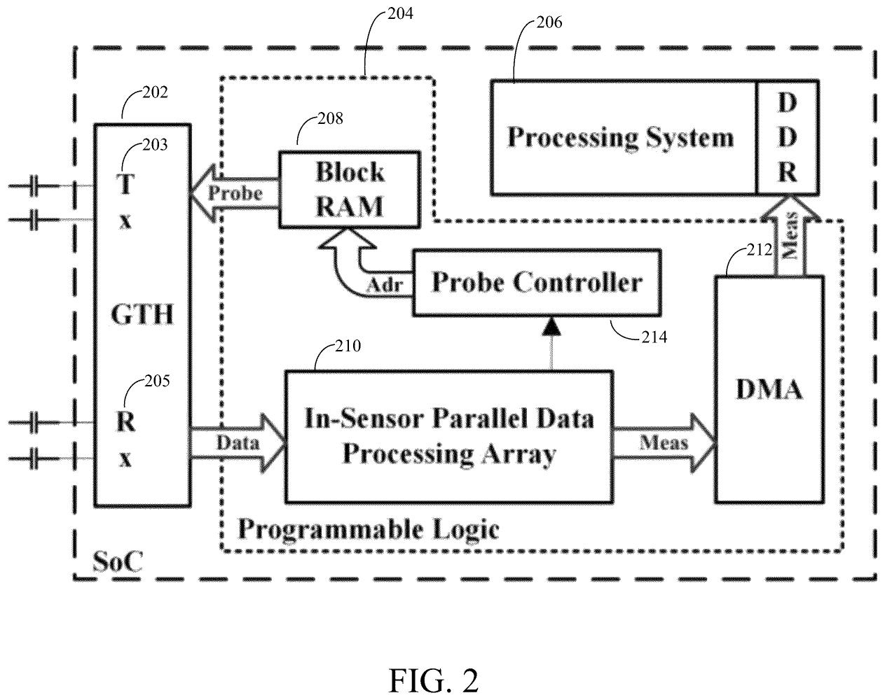

FIG. 2 is a diagram of an exemplary System-on-Chip (SoC) in accordance with an embodiment of the present disclosure. In FIG. 2, “Meas” refers to measurement, and “Adr” refers to address. The SoC design shown in FIG. 2 will now be discussed with reference to three parts: namely, transceiver 202 (e.g., a GTH transceiver in FIG. 2), programmable logic (PL) 204, and PS 206. In an embodiment, the transceiver 202 includes a transmitter 203 and a receiver 205. In an embodiment, PL 204 (e.g., in an embodiment, a controller) includes a block random-access memory (BRAM) 208, a data processing array 210 (e.g., in an embodiment, an in-sensor parallel data processing array) including a plurality of processing elements (PEs), a direct memory access (DMA) module 212, and a probe controller 214. In an embodiment, the SoC of FIG. 2 can be implemented into the system of FIG. 1. For example, in an embodiment, transmitter 203 corresponds to transmitter 106, and receiver 205 corresponds to receiver 108.

In an embodiment, PL 204 can be implemented using a controller. In an embodiment, this controller can be implemented using hardware, software, and/or a combination of hardware and software. In an embodiment, this controller can be implemented using a single device or multiple devices. In an embodiment, this controller can be implemented as a standalone special purpose device. In an embodiment, this controller can be integrated into a host device. In an embodiment, elements of a controller used to implement PL 204 can be implemented using hardware, software, and/or a combination of hardware and software. In an embodiment, elements of a controller used to implement PL 204 can be implemented using a single device or multiple devices.

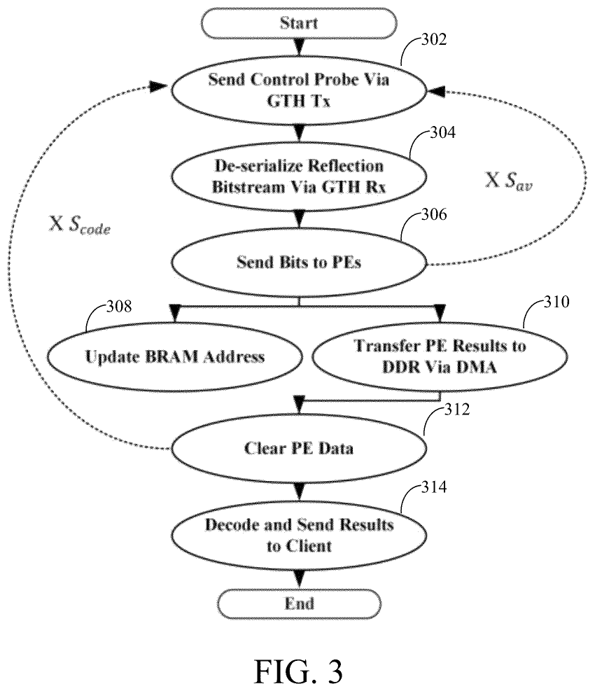

FIG. 3 is a flowchart showing the various steps throughout an exemplary measuring procedure in accordance with an embodiment of the present disclosure. In FIG. 3, S_{code} references the number of codes, and Sₐᵥ references the number of averages. In an embodiment programmable logic 204, such as a controller, can be used to perform the steps of the flowchart of FIG. 3. In step 302, a control probe is sent via a transmitter. For example, in an embodiment, a control probe can be sent from BRAM 208 to transmitter 203 for transmission. In step 304, a reflection bitstream is de-serialized via a transceiver's receiver. For example, in an embodiment, a reflection bitstream is de-serialized via receiver 205. In step 306, bits are sent to PEs. In an embodiment, an additional control probe can be sent at this time by returning to step 302. For example, in an embodiment, bits are sent to PEs of data processing array 210. In step 308, a BRAM address is updated. For example, in an embodiment, data processing array 210 sends a signal to probe controller 214 instructing probe controller 214 to update an address in BRAM 208. In step 310, PE results are transferred to DDR (double data rate) memory via DMA. For example, in an embodiment, data processing array 210 can transfer PE results to DMA module 212. In step 312, PE data is cleared. For example, in an embodiment, PE data is cleared from data processing array 210. In an embodiment, an additional control probe can be sent at this time by returning to step 302. In step 314, results are decoded and sent to a client. For example, in an embodiment, DMA module 212 can send measurements to double data rate memory of processing system 206. In an embodiment, processing system 206 can be a client device or system.

### 2.4.1. Exemplary Transceiver

In an embodiment, the transceiver 202 connected to the SFP module 102 was configured to have a data rate of 8 Gb/s for both Tx and Rx channels. This gives rise to a bit time of 125 ps, which roughly translates to a spatial resolution of 12.5 mm when used as a probe in an OTDR. Furthermore, in an embodiment, the system clock is derived from the voltage-controlled oscillator in the transceiver and is 100 MHz. As a result, the Rx acts as an 80-bit deserializer because it provides 80-bits to the PL in a single clock cycle. These settings were chosen to be compatible with the 10 Gb/s SFP+ module that was used. If the data rate of the SFP+ was increased, the performance could also be increased; the transceiver on the Ultrascale+ XCZU7EV-2FFVC1156 MPSoC can go up to 16 Gb/s, which would enable a bit time of 62.5 ps (6.25 mm spatial resolution). However, current SFP technology is limited to 25 Gb/s on a single non-return-to-zero channel, limiting the minimum spatial resolution to 4 mm. The capabilities of the high-speed transceivers are rapidly growing.

### 2.4.2. Exemplary Programmable Logic

In an embodiment, the block random access memory (BRAM) 208 is loaded with the data patterns, or codes, that are used to interrogate the FUT. Since, in an embodiment, 1023 codes are used to encode the probe, the width and depth of the BRAM is set to 1024. Thus, 1024-bits can be read in a single clock cycle when no buffers are used.

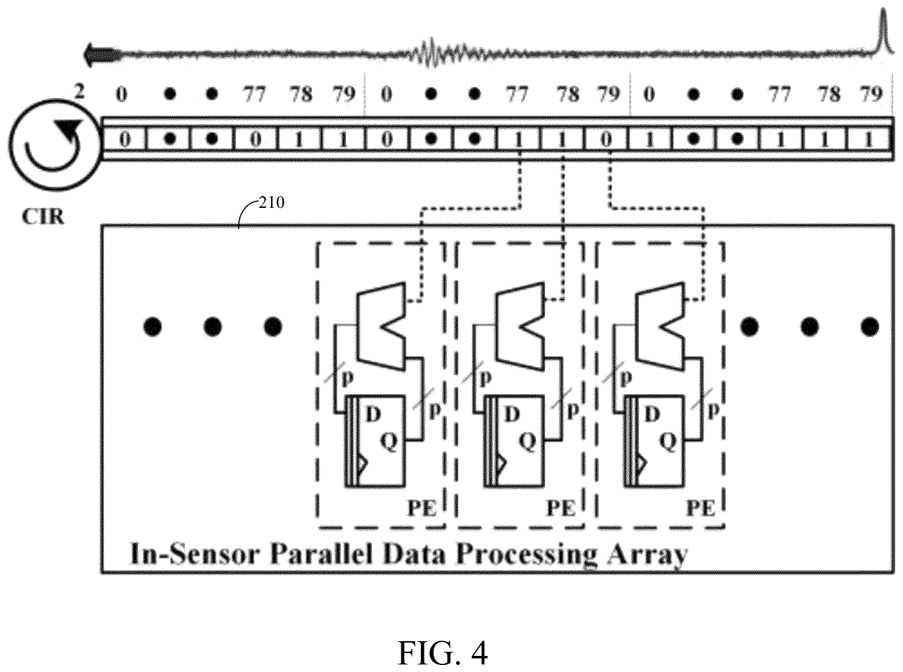

FIG. 4 is a diagram of an in-sensor parallel data processing array 210 in accordance with an embodiment of the present disclosure. In FIG. 4, “PE” references a processing element. In an embodiment, every clock cycle during a measurement, 80-bits from the Rx of the transceiver are sent to the in-sensor parallel data processing array. This processing array includes many processing elements (PEs) that contain an accumulator and a temporary storage element (p-bit FF array), as shown in FIG. 4.

In an embodiment, the samples from the FUT have a 1-to-1 mapping to a PE. Thus, 80 reflection signals from a specific 1 m section of fiber, corresponding to 80-bits, are handled by 80 PEs. As a result, parallelization can be exploited to utilize 80 PEs per system clock cycle. The maximum length of fiber that can be measured depends on the number of PEs that can be constructed in the FPGA fabric. In the exemplary implemented design discussed herein, there were enough PEs to measure a fiber up to 97 m in length. In an embodiment, the width of the FF array, p, depends on the number of averages that are being conducted on a measurement. More specifically, the number of averages being conducted should be able to be counted to accurately detect when the analog-to-probability converter outputs a logic high with probability 1.

In an embodiment, after enough samples have been acquired to preform enough averaging, a ‘done’ signal is sent to the probe controller. The data in each PE's FF array are then sent to DDR memory in the PS through a direct memory access (DMA) module 212. In an embodiment, DMA module 212 is a DMA IP core. Once the transfer is complete, the FF arrays are cleared, and another measurement will be conducted if the probe controller indicates that not all codes have been used.

An alternative approach would be to use software to process data; however, in an embodiment, this approach is undesirable compared to the advantages offered by an FPGA. More specifically, if a microcontroller was used in place of the FPGA, single bits would need to be stored in and read from memory in a sequential manor, leading to many memory transfers and clock cycles per operation. Consequently, this leads to much higher and impractical power consumption and acquisition times.

In an embodiment, a job of the probe controller 214 is to ensure the measurements are acquired in a controlled fashion. In an embodiment, when it receives notification that enough averages have been collected for a given measurement from the in-sensor parallel data processing array, it will increment the address of the BRAM to transmit the next data pattern into the FUT. The probe controller keeps track of how many data patterns need to be transmitted and how many have been transmitted so that the PS can be notified when all codes have been cycled through.

### 2.4.3. Exemplary Processing System

In an embodiment, there is a server running on the PS 206 that allows a client to communicate with it over a network. This allows the measurements stored in DDR memory to be sent to a client for optical fiber diagnostics once the server decodes the encoded backscattering traces. Additionally, the PS 206 receives different parameters from the client to setup the PL for a measurement, such as the number of averages that gets performed in the in-sensor parallel data processing array, the length of the FUT, and the initiation of a measurement.

### 2.5. Exemplary Experimental Evaluation

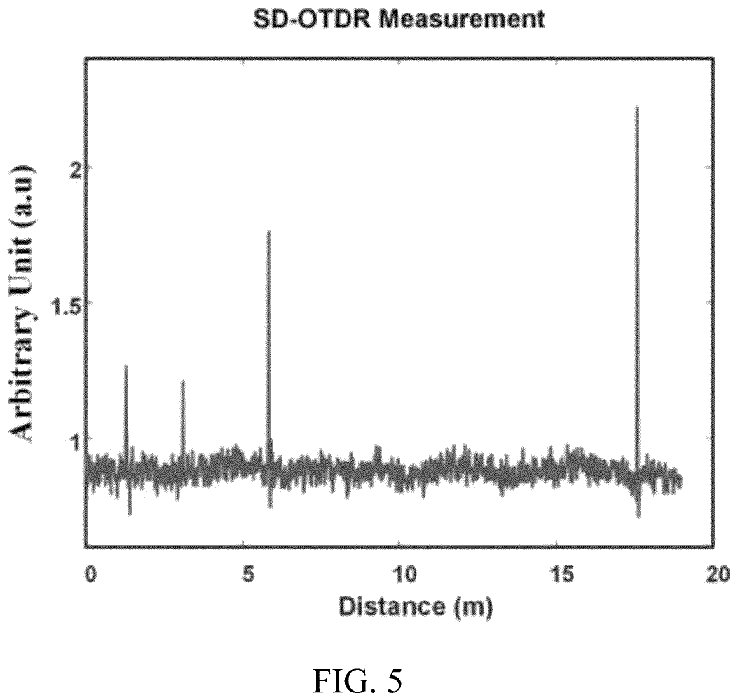

An exemplary experimental evaluation of converting a SFP module into a SD-OTDR in accordance with an embodiment of the present disclosure will now be discussed. In an embodiment, the number of averages was set to 512. In an embodiment, this value is not significant and can be lowered to achieve faster acquisition times without significantly degrading the performance. In an embodiment, when performing a diagnostic measurement of the FUT shown in FIG. 1, the data in FIG. 5 is acquired.

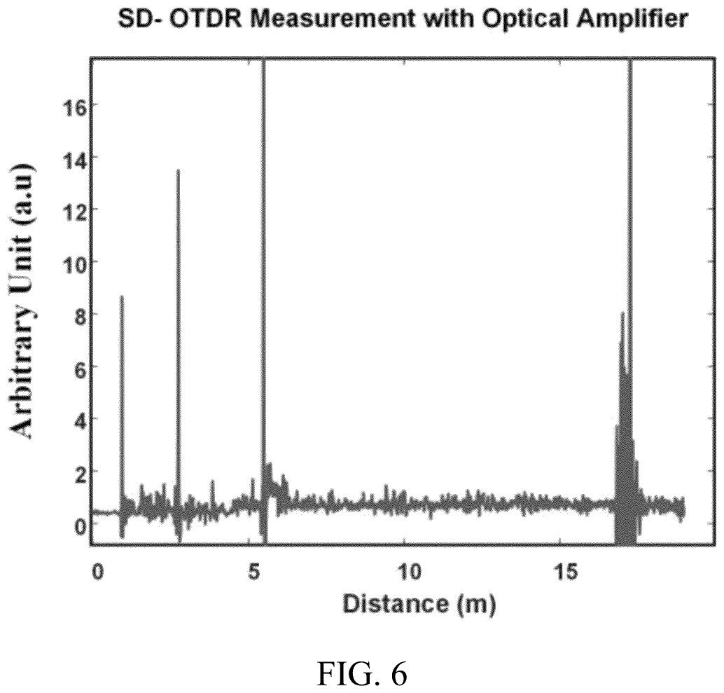

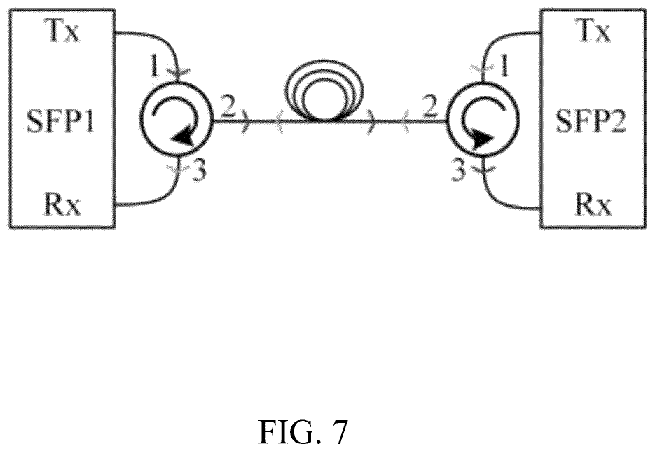

FIG. 5 is a diagram showing an exemplary SD-OTDR measurement in accordance with an embodiment of the present disclosure. FIG. 6 is a diagram of an exemplary SD-OTDR measurement with an optical amplifier in accordance with an embodiment of the present disclosure. FIG. 7 is a diagram of a bi-directional full duplex passive optical network cabling in accordance with an embodiment of the present disclosure. In an embodiment, an absolute reflectivity power is not measured by this system, so the unit of the measurement is an arbitrary unit. Nevertheless, the measurements show that the small reflections caused by the APC connector mattings at 3 m and 6 m can be detected with high resolution. In addition, the reflection caused by port 2 of the circulator at 1 m is also detected by this SD-OTDR. Thus, small discontinuities are detectable by this system even though their exact magnitude is unknown. The spatial resolution is a direct consequence of bit time and sampling rate of the high-speed transceiver and far exceeds the spatial resolution offered by conventional OTDRs deployed in industry (typically above tens of centimeters).

If an optical amplifier is used in-line between the Tx and circulator, or the optical source's power is increased, this system can also measure the Rayleigh backscattering in the fiber caused by unavoidable intrinsic impurities, as is shown in FIG. 6. In an embodiment, the backscattering level is distinguishable from the noise level that is before the first large reflection caused by the output port of the circulator. This can be used to detect excessive loss and opens the door for many other potential applications.

While the reported SD-OTDR does require the addition of a circulator to existing optical links, this is already a trend in industry to realize bi-directional full-duplex communication. Essentially, as shown in FIG. 7, there is a circulator inline at both ends of the link with a single fiber connected between transceivers. Thus, this passive optical network enables the capacity to be increased using existing cabling infrastructures. Also, it is projected that silicon photonic technology will soon allow the circulator to be integrated in a transceiver module.

Embodiments of the present disclosure demonstrate that a software defined optical time-domain reflectometer can be realized using components that are already in existence in optical communication links. That is, readily available commercialized SFP modules can be converted into state-of-the-art SD-OTDRs by using the reconfigurable nature of SoCs. As a result, there can be in-situ diagnostics in communication links without adding any overhead.

### 3. DISTRIBUTED OPTICAL FIBER SENSOR VIA IN-SENSOR PARALLEL DATA PROCESSING

Optical fibers find applications in not only telecommunication settings but also in distributed vibration, strain, and temperature sensors. Systems of optical fiber sensors face shared limitations-high system cost and large form factor. A System-on-Chip-based phase optical time-domain reflectometer in accordance with an embodiment of the present disclosure can address these limitations. An exemplary system in accordance with an embodiment of the present disclosure can directly map optical reflections at different locations along the length of a fiber to a processing element array in a Field-Programmable Gate Array (FPGA) for real-time in-sensor parallel data processing. The design in accordance with an embodiment of the present disclosure features a minimal overhead (low cost and small form-factor), allowing it to find many different applications in industry such as structural health monitoring and distributed temperature sensing on unmanned vehicles or robotics.

Optical fiber has become a critical instrument in modern society. It is desired for its many advantages such as immunity to electromagnetic interference, low-loss, and very high bandwidth. Consequently, it has found its way into sensing applications. As the technology continues to become more mature, the cost of the required instrumentation, such as laser source and photodetectors, is decreasing. Furthermore, the inherent lightweight, high sensitivity to environmental variations, and ability to withstand harsh environments makes the optical fiber desirable over its electrical counterpart.

Embodiments of the present disclosure further increases the desire to use optical fiber by introducing a system-on-chip (SoC)-based phase sensitive optical time-domain reflectometer (phase-OTDR) implementation that utilizes a Xilinx Ultrascale+ to realize a distributed optical fiber sensor with a minimal overhead. The proposed design removes the necessity of costly and/or bulky optical components, such as high coherence light source, tunable laser source, polarization maintaining fiber, polarization diversity receiver, coherent receiver, and fiberoptic modulator. In addition, the proposed design also removed the necessity of an analog-to-digital converter (ADC) chip. This approach is shown to be capable of achieving a spatial resolution of 12.5 cm, strain sensitivity of 661 nϵ, temperature sensitivity of 0.08° C., and sensing distance of 110 m.

Importantly, embodiments of the present disclosure can achieve dynamic measuring capability on the order of kHz by taking advantage of the reconfigurable nature of the SoC/Field-Programmable Gate Array (FPGA) architecture. As an enabler, it directly maps optical reflections at different locations along the length of a fiber to a processing element (PE) array in an FPGA to achieve real-time in-sensor parallel data processing. Furthermore, the system's digital hardware design enables it to adapt based on the application it is deployed for as opposed to other implementations that target a specific industry.

Embodiments of the present disclosure offer a competitor to the optical frequency-domain reflectometer (OFDR)-based sensor with a cost at least two orders of magnitude less. More specifically, industrial OFDR-based sensors are on the market with a price tag over $100,000, significantly limiting its wide adoption, while the estimated cost of the proposed system is less than $1,000. Additionally, considering the SoC used in this system can also be used, either simultaneously or in a timeshared fashion, for other tasks, such as real-time feedback control, real-time signal processing including machine learning acceleration, data/video collection for other sensing modalities in a complex system (such a car), etc., the real cost for the proposed system is expected to be substantially less than $1,000.

Conventional optical time-domain reflectometers (OTDRs) are used to extract the magnitude of the Rayleigh backscattering to characterize the loss within a fiber. These systems, however, are not able to measure temperature or strain variations induced on the fiber and cannot be used in sensing applications. As a result, Brillion optical-time domain reflectometers (BOTDRs), Raman optical time-domain reflectometers (ROTDRs), and phase-OTDRs have been proposed for sensing applications. All have their own advantages; however, a common drawback is faced from their struggle to achieve a spatial resolution below 1 m without significantly increasing cost and complexity.

Another way to sense temperature and strain variations on optical fiber is to work in the frequency domain. More specifically, OFDR-based sensors have been favored in industries, such as automotive, for their superior spatial resolutions, which can be in the centimeter range; however, this enhanced spatial resolution comes at the cost of other performance metrics. Without complex phase error compensation techniques to overcome the coherent length limitation of the laser source, the measuring distance of these sensors is limited to tens of meters. Additionally, to maximize the coherent length of the source, a narrow linewidth laser must be used, adding cost to the design. These sensors are also costly and bulky in nature due to their linear frequency-swept source. Another drawback is realized by the polarization fading of the reflecting events, ultimately effecting the quality of the interference with a reference event. Polarization maintaining components can be used to combat this problem, but extra care and polarization calibration process must also be taken to ensure external perturbations are not incident on the fiber. The OFDR's sensitivity, on the order of hundreds of millikelvin and μϵ, is superior to that of BOTDR or ROTDR-based sensors; however, its high cost and bulkiness makes it undesirable for wide deployment.

An exemplary design in accordance with an embodiment of the present disclosure uses the temperature of a semiconductor laser as a technique to control its frequency for distributed optical fiber sensing based on a direct-detection phase optical time-domain reflectometer. In an embodiment, a lookup table is implemented to measure distributed temperature or strain on optical fiber. In an embodiment, the increased noise of avalanche photodetectors when biased close to their breakdown voltage is utilized to increase the dynamic range of an analog-to-probability converter. An exemplary system in accordance with an embodiment of the present disclosure offers the smallest form-factor and minimal overhead design of any distributed optical fiber sensor to date.

### 3.1. Exemplary Direct-Detection Phase-OTDR

In an embodiment, the direct-detection phase-OTDR measures the interference of reflections caused by inhomogeneous particles within the fibers core that are there because of imperfect manufacturing processes. These unavoidable imperfections are distributed throughout the core of the fiber. The backscattering profile is known as Rayleigh backscattering. When a coherent optical probe is transmitted into an optical fiber, the coherent mixing of multiple reflections causes the Rayleigh backscattering profile to appear “jagged.”

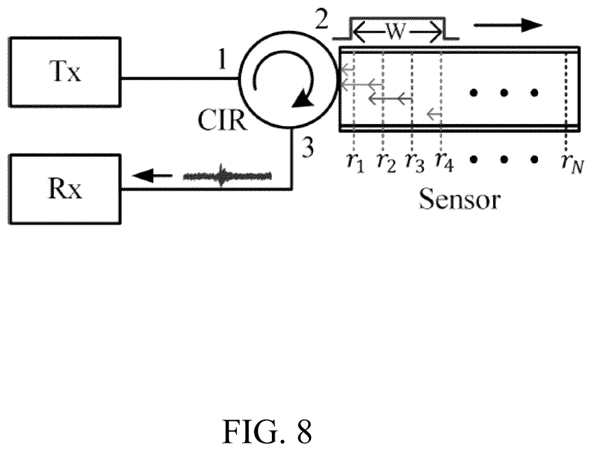

FIG. 8 is a diagram illustrating direct-detection phase-OTDR theory in accordance with an embodiment of the present disclosure. In FIG. 8, “Tx” references transmitter, “Rx” references receiver, “CIR” references circulator, “W” references pulse width, “rᵢ” references reflection from backscattering center i. An example of how multiple reflections interfere as the optical probe propagates down a fiber is presented in FIG. 8, where the optical probe width, W, covers four of the N backscattering centers in the sensor fiber: namely, r₁, r₂, r₃, and r₄. It is apparent that in this example, up to two backscattering centers interfere at a given time since up to two can reside in half the pulse width.

In an embodiment, the optical power, p (t), measured at the receiver (Rx) can be derived from the backscattered electromagnetic wave, e (t), as:

$$P ( t ) = {\vert e ( t ) \vert}^{2} = {P}_{D} ( t ) + {P}_{I} ( t ) \qquad ( 1 )$$

where P_{D}(t) is the optical power generated by individual backscattering centers, and P_{I}(t) is the optical power generated by the coherent interference between backscattering centers underneath the optical probe at a given time, t. In an embodiment, if the coherent optical probe is modeled to be rectangular in nature with a pulse width of W, the two components of the measured power can be expressed as:

$$\begin{matrix}{P}_{D} ( t ) = {\sum }_{i = 1}^{N} {a}_{i}^{2} rect ( \frac{t - {τ}_{i}}{W} ) , & ( 2 ) \\ {P}_{I} ( t ) = 2 {\sum }_{i = 1}^{N} {\sum }_{j = i + 1}^{N} {a}_{j} {a}_{i} cos ( {ϕ}_{ij} ) rect ( \frac{t - {τ}_{i}}{W} ) rect ( \frac{t - {τ}_{j}}{W} ) , & ( 3 )\end{matrix}$$

where aᵢ, aⱼ, τᵢ, and τⱼ are the amplitudes and delays of the ith and jth backscattering centers, respectively, and ϕᵢⱼ is the phase related to the interference pattern, expressed as:

$${ϕ}_{ij} = 2 v ( {τ}_{i} - {τ}_{j} ) , \qquad ( 4 )$$

where v is the optical frequency. The term related to the attenuation introduced by the fiber is neglected in (2) and (3) since the attenuation is negligible for fibers on the order of hundreds of meters in length.

In an embodiment, the delays of the backscattering centers are related to distance, d, by dᵢ=vₚτᵢ/2, where vₚ is the propagation velocity of the light in the fiber. Thus, (4) can be written as:

$${ϕ}_{ij} = 4 {vv}_{p} ( {d}_{i} - {d}_{j} ) , \qquad ( 5 )$$

which shows that the Rayleigh backscattering profile is directly proportional to the distance between backscattering centers. In an embodiment, when the fiber undergoes a temperature change, this distance will vary because of thermal expansion and refractive index variation. Furthermore, in an embodiment, if strain is applied to the fiber, the distance will also vary due to the physical stretching and compression that is applied to the fiber.

Importantly, the backscattering profile is also directly proportional to the optical frequency of the laser source. As a result, v can be controlled to compensate for a changing distance between backscattering centers. The frequency change required to compensate such a change can then be used to calculate either the temperature or strain variation that the optical fiber has undergone by utilizing knowledge of fiber Bragg gratings. More specifically, we can use the relationships:

$$\begin{matrix}\frac{Δ v}{{v}_{o}} = - ( 1 - {p}_{e} ) Δε = - 7.81 Δε , & ( 6 ) \\ \frac{Δ v}{{v}_{o}} = - ( {γ}_{th} + {γ}_{n} ) Δ T = - 6.67 \times {10}^{- 6} Δ T & ( 7 )\end{matrix}$$

where vₒ and Δv are the initial and change in optical frequency, respectively, pₑ is the strain-optic coefficient of silica (˜0.22), Δε is the strain variation, γₜₕ is the coefficient of thermal expansion, γₙ is the thermal-optic coefficient of silica, and ΔT is the temperature variation.

An advantage of this technique is the fact that the interference is constrained to half the probe width, or W/2. As a result, the coherence length of the laser is no longer a concern when using pulse widths of 10 ns or less, which is desired for achieving spatial resolutions below 1 m. Additionally, the light's polarization and fibers' environment are considered to be stable in these small sections.

### 3.2. Laser Frequency Control

Previous methods to scan the frequency of the laser to find the compensation frequency include chirping the optical frequency by controlling the lasers driving current. This method has been proven to achieve fast acquisition times, ultimately expanding its dynamic measuring capability; however, it requires a large overhead current curve generator as well as an optical amplifier to generate the optical probe from the lasers continuous-wave output.

Embodiments of the present disclosure introduce an alternative low-cost and small form-factor solution to scan the frequency of the laser. More specifically, the laser's frequency is controlled by varying its temperature; the output wavelength temperature tunability of a distributed feedback semiconductor laser (DFB-SCL) is typically 0.08 nm per degree Celsius and the temperature range for tunability is typically 15° C.; thus, a frequency scan of 149.73 GHz can be realized. Relating this to (6) and (7), the sensing range can be 114.23° C. or equivalently 247.62μϵ.

In an embodiment, a system's laser source should be temperature controlled since its performance is highly dependent on its operating temperature. As a result, it is common for optical systems to be temperature controlled through thermo-electric coolers (TECs), whose controllers can be realized in a small form-factor and cost-effective IC. This means the technique does not add overhead to the system. A concern that one may have, however, is the fact that controlling the laser through its temperature is much slower than through its driving current, limiting its dynamic measuring capability. While true, this drawback can be overcome by implementing a lookup table.

### 3.3. Finding the Compensation Frequency

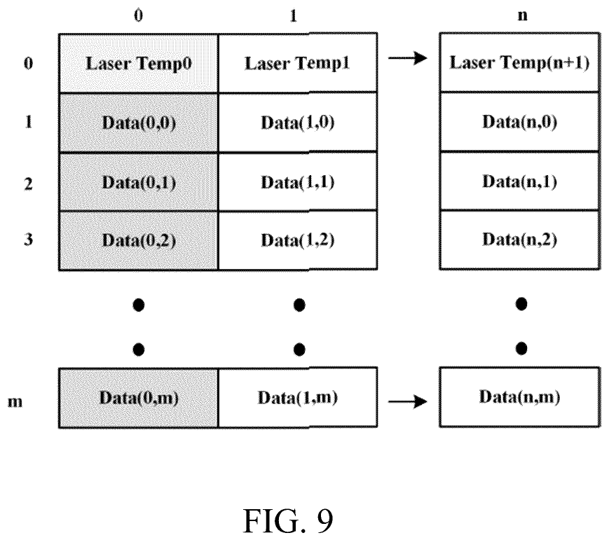

In an embodiment, a lookup table of backscattering measurements is generated by measuring the backscattering profile of the sensor fiber at different laser temperatures. FIG. 9 is a diagram illustrating an exemplary structure of a lookup table in accordance with an embodiment of the present disclosure. The first row of the table includes the different laser temperatures, while the subsequent rows under a particular column correspond to the backscattering profile acquired at a given optical frequency, related by the temperature in the first row. For example, the first laser temperature is highlighted in green, and the backscattering profile acquired while operating the laser at this temperature is highlighted in gray; each row, starting at row 1, represents one sample of the sensing fiber. As a result, there are m samples taken of the sensing fiber while operating the laser at n+1 different temperatures.

In an embodiment, the generation of such a lookup table can be conducted as part of the system's power up sequence and stored in memory. Additionally, it can be updated to recalibrate the sensor to its environment. After calibration, a backscattering measurement can be conducted while the laser is operating at a particular temperature to detect either temperature or strain variation on the optical fiber. More specifically, if there is temperature or strain applied to the fiber, the backscattering profile will look like a different column in the lookup table.

In an embodiment, to match a backscattering profile to a laser temperature in the lookup table, the similarity of the measurement, x, with each column of data samples, y, is calculated after x and y have been normalized and their DC components removed. The similarity, S_{xy}, is determined by taking the inner product of x and y:

$${S}_{xy} = {\sum }_{q = 0}^{m} x [ q ] y [ q ] . \qquad ( 8 )$$

Thus, the temperature in the first row of the column that produced the highest similarity will be used to find the compensation frequency that can be applied in (6) or (7). This calculation is computationally simple, enabling it to easily be conducted in the reconfigurable fabric of an SoC. Importantly, the optical output power variations due to a changing operating temperature do not impact measurements due to the normalization process; if the optical probe maintains its shape, the backscattering profile remains unchanged.

### 3.4. Exemplary Systems

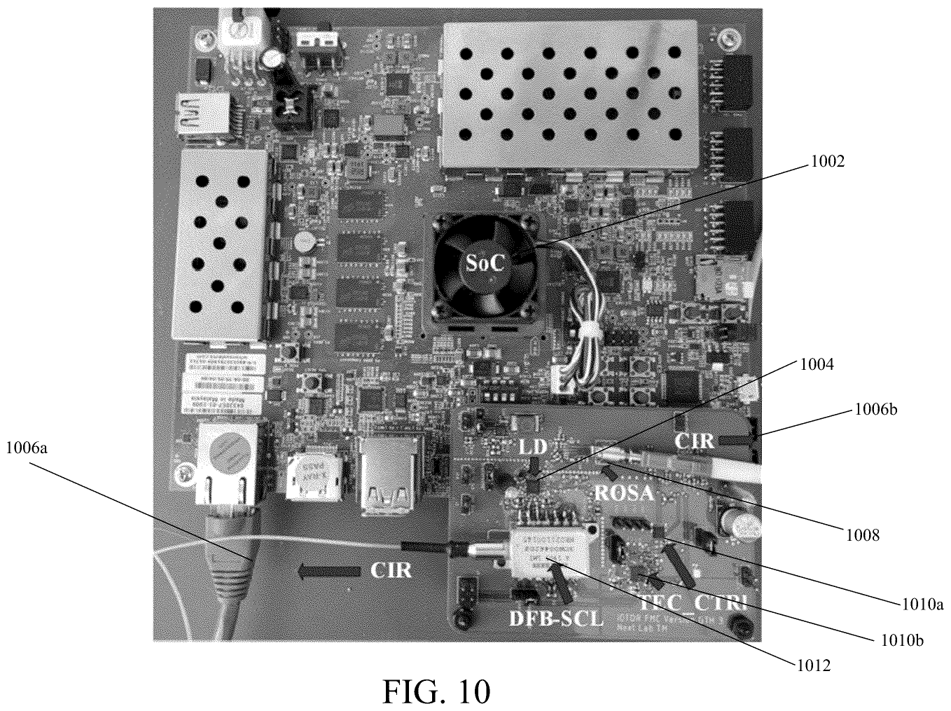

FIG. 10 is a diagram showing an exemplary OTDR system in accordance with an embodiment of the present disclosure. In FIG. 10, “SoC” references System-on-Chip, “LD” references laser driver, “DFB-SCL” references distributive feedback semiconductor laser, “CIR” references circulator, “ROSA” references receiver optical sub-assembly, “TEC_CTRL” references thermos-electric cooler controller, and “DFB-SCL” references distributed feedback semiconductor laser. FIG. 10 includes an SoC 1002, an LD 1004, circulators 1006a and 1006b, ROSA 1008, TEC_CTRLs 1010a and 1010b, and DFB-SCL 1012.

In an embodiment, at the core of the OTDR is a Xilinx Ultrascale+ XCZU7EV-2FFVC1156 SoC housed on a ZCU104 evaluation board. Furthermore, a laser driver (LD), DFB-SCL, and avalanche photodetector (APD) receiver optical subassembly (ROSA) are all integrated onto a custom 4-layer daughter board that connects to the SoC through a field-programmable gate array (FPGA) mezzanine card connector (FMC). The temperature of the laser can be controlled through an external temperature controller or with a low-cost and small form-factor integrated TEC controller. The output of the DFB-SCL is sent through a circulator and into a sensor fiber. The measurements from the sensor fiber then propagate back through the circulator and will be incident on the ROSA. Lastly, an external in-line erbium doped fiber amplifier (EDFA) is an optional addition based on the desired application and would be placed between the DFBSCL and circulator. In an embodiment, this design offers a truly minimal overhead by utilizing the computational power and dynamic reconfigurability of the SoC. Besides the SoC, only the unavoidable components that will exist in any electro-optical system are used; namely, the LD, DFB-SCL, ROSA, and temperature controller.

### 3.4.1. Exemplary Data Acquisition

In an embodiment, an input buffer of the transceiver is used to convert the analog signals into digital information that can be analyzed by the SoC. This is enabled by the analog-to-probability converter (APC) technology. In an embodiment, unlike traditional data converters, the APC utilizes the noise incident on the input buffer. In an electro-optical system, this noise can be contributed from three sources: thermal (σₜ²), shot (σₛ²), and dark (σ_{D}²) noise, which can be described as the following when using an APD:

$$\begin{matrix}{σ}_{t}^{2} = \frac{4 kT}{{R}_{L}} , & ( 9 ) \\ {σ}_{s}^{2} = 2 {qP}_{in} {RF}_{A} {M}^{2} Δ f , & ( 10 ) \\ {σ}_{D}^{2} = 2 {qI}_{dark} {F}_{A} {M}^{2} Δ f , & ( 11 )\end{matrix}$$

where k is Boltzmann's constant, T is the temperature, R_{L} is the load resistance, q is the electron charge, Pᵢₙ is the incident optical power, R is the APD responsivity, FA is the excess noise factor, M is the multiplication factor, I_{dark} is the APD dark current, and Δf is the effective bandwidth of the receiver.

In an embodiment, when a time-invariant voltage is incident on the buffer, it will have a certain probability of triggering a logic high output if it falls within the coverage of the noise. As a result, the accumulated number of logic high outputs of the buffer over a number of samples is a direct representation of the analog signal at its input. The probability is related to the incident voltage by the cumulative density function of the noise.

A feature of this data conversion technique is that rather than utilizing low-noise components to optimize the signal-to-noise ratio and improve the sensitivity of the receiver, a large noise is desired to optimize the receiver's dynamic range. Since the Rayleigh backscattering reflectivity is on the order of −82 dB for standard single-mode telecommunication fiber with a Ins wide optical probe, a sensitive receiver is required. One way to improve the receiver would be to increase the multiplication factor of the APD by increasing its bias voltage. Consequently, this also increases dark and, as seen in (10) and (11), also increases the noise power. Unlike traditional converters, the APC uses this to its advantage. As a result, the multiplication factor of the APD can be increased to improve both the receivers gain and dynamic range. Care must be taken, however, to not bias the APD above its breakdown voltage.

### 3.4.2. Exemplary SoC Design

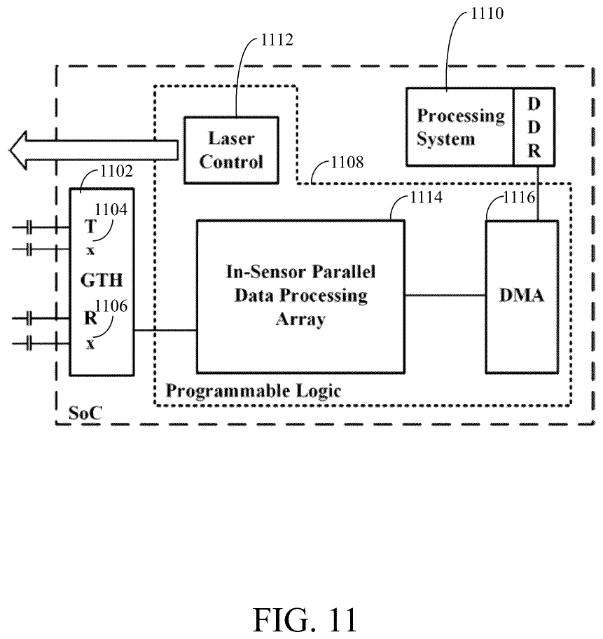

FIG. 11 is a block diagram of an exemplary SoC design in accordance with an embodiment of the present disclosure. FIG. 11 includes a transceiver 1102 including a transmitter 1104 and a receiver 1106. FIG. 11 includes a processing system 1110 and programmable logic 1108. Programmable logic 1108 includes a laser control module 1112, a data processing array (e.g., an in-sensor parallel data processing array) 1114, and a DMA module 1116. In an embodiment, the transceiver 1102 operates at a data rate of 8 Gb/s for both the Tx and Rx channels. As a result, the smallest probe width is 125 ps, and the sampling rate is 8 GSPS. Furthermore, the system clock is derived from the GTH voltage-controlled oscillator and is 100 MHz. Ultimately, the GTH Rx acts as an 80-bit de-serializer providing 80 samples from the sensing fiber to the programmable logic (PL) in one system clock cycle.

In an embodiment, the processing system (PS) 1110 is loaded with a remote server to enable a client, controlled by a host computer, to communicate remotely over a network. The client operates through a user interface that enables an operator to control many different parameters within the PL through the PS. Additionally, the PS is responsible for handling both the transfer of measurement results into DDR memory and the transfer of measurement results from memory to the client. The lookup table generated during a calibration process, shown in FIG. 9, can also be held in memory. There are different ways of performing the similarity calculation to match a measurement with a table entry including software through the PS or hardware through dedicated digital-signal processing (DSP) fabric. This processing can be performed while a subsequent measurement is being conducted to optimize dynamic measuring capability.

In an embodiment, the PL 1108 includes three major blocks; namely, laser control 1112, data processing array 1114, and a direct memory access (DMA) module 1116. The laser control is responsible for programming the laser driver through a 3-wire interface based on values that are set by the client and relayed from the PS. This programming interface enables the laser's bias and modulation current to be set as well as the laser drivers, equalization, eyecrossing, and de-emphasis.

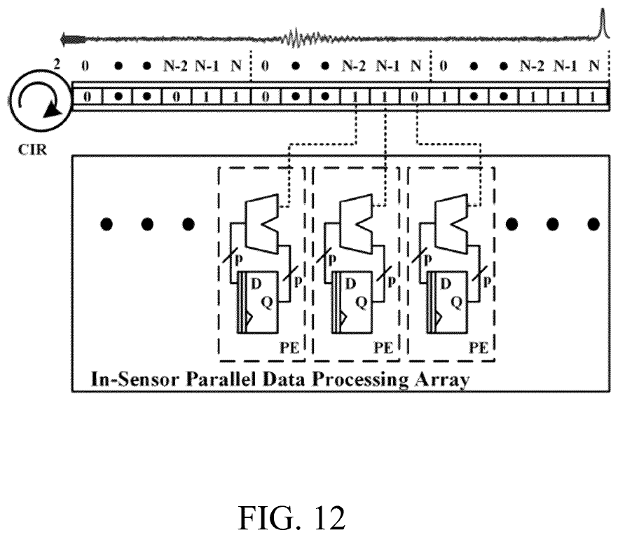

FIG. 12 is a block diagram illustrating an exemplary in-sensor parallel data processing module in accordance with an embodiment of the present disclosure. In FIG. 12, “PE” references processing element. In an embodiment, the in-sensor parallel data processing module is responsible for handling the N+1-bit de-serialized data from the transceiver Rx. In an embodiment, it includes many processing elements (PE), each with an accumulator and temporary storage element, i.e. p-bit flip-flop array. The sampled reflections from the sensing fiber have a 1-to-1 mapping to a PE. As a result, the reflections can be thought of as a bitstream representing the physical property of the fiber. Since N+1 samples are acquired in one system clock cycle, parallelization can be exploited in the PL to utilize N+1 PEs per system clock cycle. As mentioned in section III.B, the number of logic high outputs for a given sample is accumulated and temporarily stored in its corresponding PE. Thus, the width of the flip-flop arrays, p, depends on the number of averages that are being conducted. The sensing distance of the system is thus limited by the number of logic elements available in the FPGA.

Once all the data has been accumulated in the temporary storage elements in the PEs, the data is transferred to DDR memory through the DMA module. Once the transfer is complete, the temporary storage is cleared to prepare for the next sensor measurement. Significantly, software alternatives are not comparable to the advantages offered by the FPGA. Due to the statistical measurements being conducted, single bits would need to be stored in and read from memory in a sequential manor. This leads to a substantially larger number of memory transfers and clock cycles per operation. Consequently, using a microcontroller to implement this design not only increases acquisition time but also consumes more power.

In an embodiment, the SoC of FIG. 11 can be implemented into the system of FIG. 1. For example, in an embodiment, transmitter 1104 corresponds to transmitter 106, and receiver 1106 corresponds to receiver 108. In an embodiment, PL 1108 can be implemented using a controller. In an embodiment, this controller can be implemented using hardware, software, and/or a combination of hardware and software. In an embodiment, this controller can be implemented using a single device or multiple devices. In an embodiment, this controller can be implemented as a standalone special purpose device. In an embodiment, this controller can be integrated into a host device. In an embodiment, elements of a controller used to implement PL 204 can be implemented using hardware, software, and/or a combination of hardware and software. In an embodiment, elements of a controller used to implement PL 204 can be implemented using a single device or multiple devices.

### 3.5. Exemplary Experimental Results

### 3.5.1. Strain

In an embodiment, to test an optical fiber sensor in accordance with an embodiment of the present disclosure, Young's Modulus was measured by applying stress on a 50 cm segment at the end of a fiber using a pulley and weights. The sensing range was set to 110 m, and the number of averages used was 512. As a result, the duration of a sensor measurement is 563.2 μs. This results in a sensor sampling rate of 1.8 kHz. From Nyquist theory, this translates to the ability to measure dynamic events with a frequency up to 888 Hz. Furthermore, the required resources for the entire design include 54,146 LUTs, 332 LUT RAMs, and 92,849 flip-flops. Of these total resources, the in-sensor parallel data processing module utilizes 50,948 LUTs, and 88,646 flip-flops. The stress applied can be determined using the following relationship:

$$Stress = \frac{{gW}_{kg}}{A} , \qquad ( 12 )$$

where g is the acceleration due to gravity (9.81 m/s²), W_{kg} is the weight applied in kilograms, and A is the cross-sectional area of the fiber. From this stress and the measured stain, the Young's Modulus, Y, of the fiber can be determined from:

$$Y = \frac{Stress}{Strain} . \qquad ( 13 )$$

In the experiments performed, three fibers were tested of two Corning® products: namely, LEAF® and SMF-28®. Previous evaluation on the Young's Modulus of optical fibers can be utilized for verification. In recent works, Young's Modulus was measured to be, on average, 22 GPa for as-received fiber.

The lookup table was generated by varying the laser temperature from approximately 24.02° C. to 22.27° C. in steps of 0.01° C. This enables a strain measurement range of approximately 115.64 us with a sensitivity of ˜661 nϵ. The sensitivity limitation is due to the smallest temperature step available by the temperature controller.

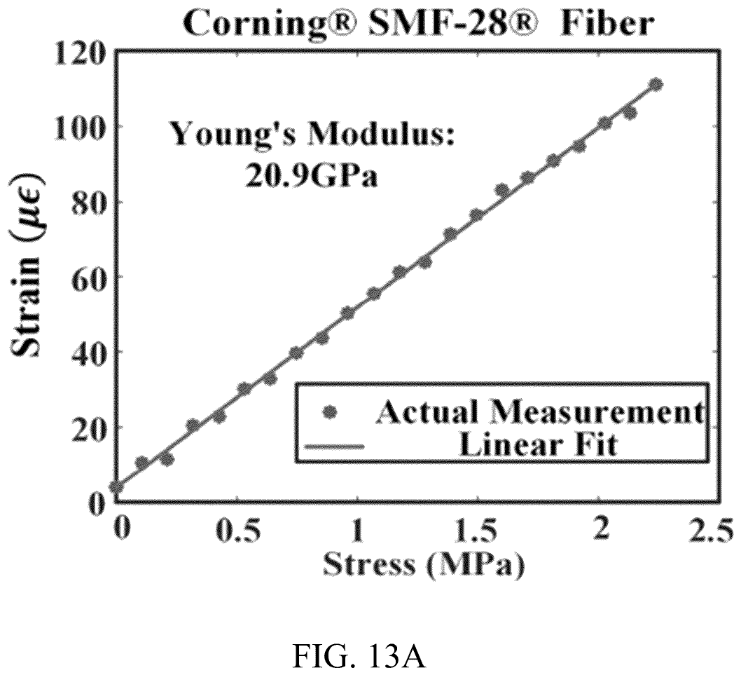

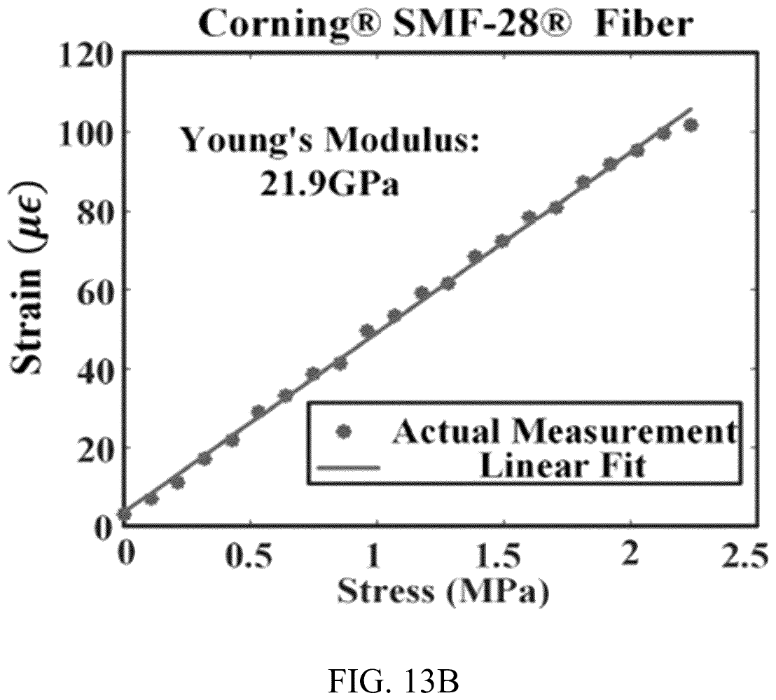

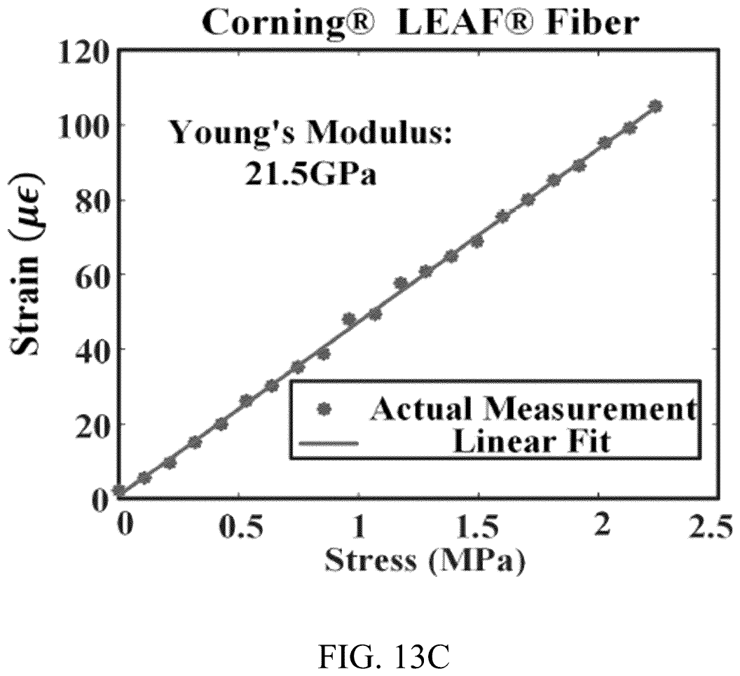

The measurements of Young's Modulus for the three fibers are shown in FIGS. 13A-13C. FIG. 13A is a diagram illustrating an exemplary measurement of Young's Modulus for an SMF-28® fiber in accordance with an embodiment of the present disclosure. FIG. 13B is another diagram illustrating an exemplary measurement of Young's Modulus for an SMF-28® fiber in accordance with an embodiment of the present disclosure. FIG. 13C is a diagram illustrating an exemplary measurement of Young's Modulus for a LEAF® fiber in accordance with an embodiment of the present disclosure. As expected, there is a strong linear relationship between the applied stress and the measured strain. The fiber under test was not in an environmentally stable location during the measurements. Due to the inability to distinguish a difference between temperature and strain variations, this could give rise to slight errors. The average value obtained across the three fibers was 21.43 GPa.

### 3.5.2. Temperature

In an embodiment, to test the capability of the system to measure temperature, a lookup table was generated by varying the laser temperature from approximately 24.02° C. to 22.52° C. in steps of 0.01° C. This enabled an environmental temperature change of up to 11.43° C. to be detected with a sensitivity of approximately 0.08° C. Again, this sensitivity is limited by the temperature controller. This sensing range is used to demonstrate the concept and can further be increased. Like the strain experiments, the sensing distance was 110 m, and the number of averages used was 512. As a result, the required resources remain the same. The spatial resolution for the experiments performed in this section was 50 cm.

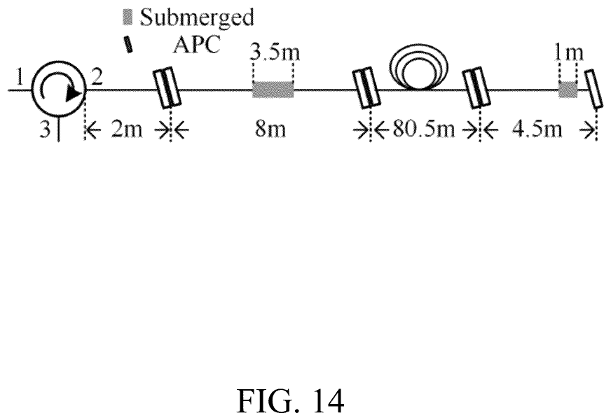

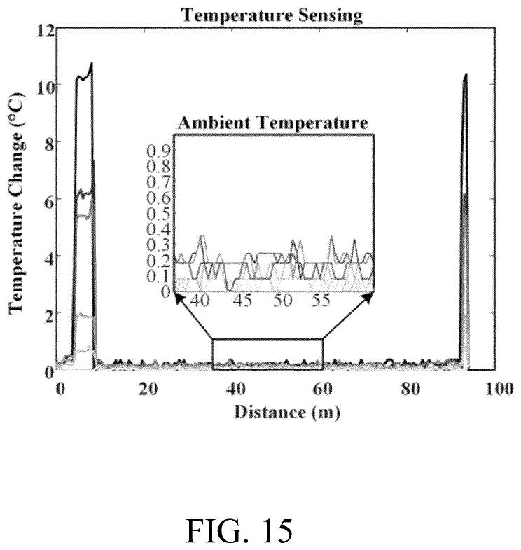

FIG. 14 is a diagram illustrating an exemplary breakdown of the sensing fiber used in the temperature sensing experiments in accordance with an embodiment of the present disclosure. FIG. 15 is a diagram illustrating exemplary experimental results for temperature sensing in accordance with an embodiment of the present disclosure. In an embodiment, there are two portions of various length submerged in a water bath while the water was both heated and cooled. This showcases the ability to measure both rising and falling temperatures. In FIG. 15, the system's ability to measure temperature variations in a distributed fashion is confirmed.

### 3.6. Exemplary System Trade-Offs

A major advantage offered by the SoC at the core of an optical fiber sensor in accordance with an embodiment of the present disclosure is the ability to adapt based on the desired application. Its reconfigurable nature enables many different parameters to be adjusted; however, as with all things in nature, there is always a trade-off associated with increasing the performance of one characteristic. The different characteristics that can be optimized in this design and the consequences of doing so are highlighted in Table I and will be described in more detail in the following subsections.

TABLE 1
Exemplary System Trade-Offs

| Desired Characteristic | Consequence |
|---|---|
| Low Cost/Complexity | Higher acquisition time |
| High Spatial Resolution | Higher acquisition time, lower |
| | dynamic range, or higher cost |
| Low Acquisition Time | Higher cost and/or lower spatial |
| | resolution |

### 3.6.1. Low Cost/Complexity

One of the major contributions to the cost, form-factor, and complexity of a system in accordance with an embodiment of the present disclosure is the EDFA. In an embodiment, the EDFA is used to achieve a high enough signal-to-noise ratio to obtain a strong confidence level in the similarity measurement. There is, however, a way to remove the EDFA from the equation, ultimately reducing the cost, form factor, and complexity of the system. In an embodiment, this can be accomplished by using a backscattering enhanced fiber rather than standard telecommunication fiber and performing more averaging. Of course, by performing more averaging, the acquisition time increases, and the dynamic measuring capability decreases.

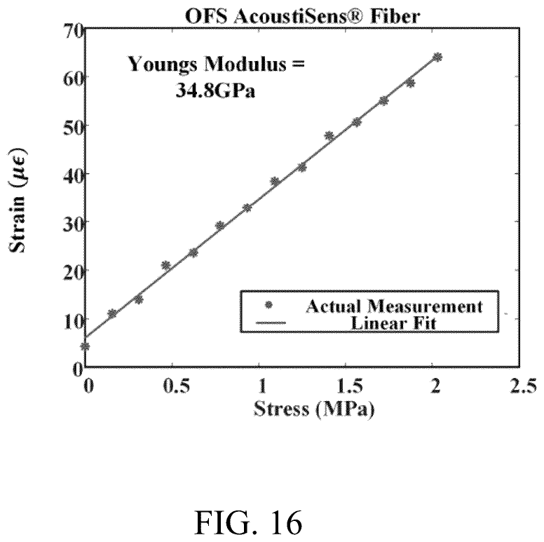

In an embodiment, to demonstrate the systems performance without an EDFA, an OFS AcoustiSens® fiber, which has a backscattering enhancement of 10 dB, was applied as the sensing fiber and the number of averages was increased to 2²⁴. Young's Modulus was then measured using the same technique discussed above. FIG. 16 is a diagram illustrating a Young's Modulus measurement without an EDFA in accordance with an embodiment of the present disclosure. Importantly, the sensing fiber has different properties than standard telecommunication fiber, which results in a different Young's Modulus. The accuracy, however, is confirmed by the linearity of the stress and strain relationship. In an embodiment, this linear relationship is only realized on the section of the fiber under stress.

### 3.6.2. High Spatial Resolution

In an embodiment, the spatial resolution can be improved several different ways. One way is to use a technique by acquiring samples in both the frequency and time-domain to increase the amount of information that is acquired of a given fiber. The second technique can be applied to systems that do not expect large temperature or strain variations to happen rapidly. This assumption depends on the environment in which the sensor is deployed or the rate at which the sensor is read. In most applications, such as structural health monitoring, this is a valid assumption.

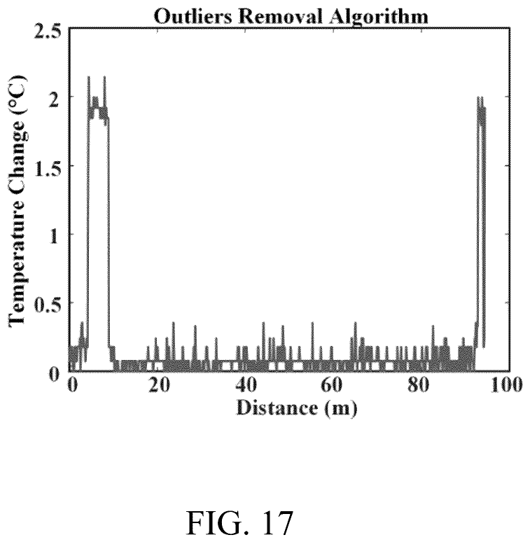

In an embodiment, the technique includes applying an algorithm to remove outliers from a measurement. These outliers can be removed by applying a threshold to determine if the data is reasonable or not. If the data is not reasonable, the previous measurement will be kept. To demonstrate this technique, a threshold of 2° C. was selected as the threshold using the setup that produced the measurements in FIG. 15; however, the spatial resolution was reduced to 12.5 cm. The measurement obtained from the sensor is presented in FIG. 17. FIG. 17 is a diagram illustrating experimental results with a spatial resolution algorithm to remove outliers in accordance with an embodiment of the present disclosure. Importantly, this method can be applied to strain measurements as well; in an embodiment, a threshold of 2° C. translates to a strain threshold of 17.38μϵ.

### 3.6.3. Low Acquisition Time

There are several different methods that can be adapted to reduce the acquisition time. One method is to increase the output power of the laser to reduce the number of averages that are required; however, doing so adds unwanted cost to the design. Another approach is to limit the sensing range to ensure all the samples can be saved in real-time with the hardware resources available. Longer sensing ranges can be used by segmenting the measurements out and later piecing them together. The time required to measure the entire fiber is thus proportional to the number of segmentations used. This approach may not be applicable to every application. Lastly, the number of PEs that are available to save samples in real-time can be increased, but this also adds more cost to the design.

Embodiments of the present disclosure provide an SoC-based distributed optical fiber sensor that can achieve a strain sensitivity of 661 nϵ and a temperature sensitivity of 0.08° C. In addition, the demonstrated spatial resolution of 12.5 cm far exceeds conventional optical time-domain reflectometer-based designs, which are on the order of meters.

A feature of an exemplary SoC in accordance with an embodiment of present disclosure is the ability to adapt to different applications. Different techniques to optimize different desired characteristics were given with experimental demonstrations outlining the potential of this sensing system. Moreover, the design offers the most cost-effective (at least 2 orders of magnitude less than conventional systems) and smallest form-factor (entire interrogator on a PCB) of any distributed optical fiber sensor. As a result, it can find applications in many industrial fields such as structural health monitoring, distributed vibration sensing, perimeter monitoring, and distributed temperature sensing.

### 4. CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented using a computer program executing on a machine, using a computer program product, or using a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A reflectometer, comprising:
a processing system;
a transmitter;
a receiver configured to de-serialize a reflection bitstream; and
a controller coupled to the processing system, the transmitter, and the receiver, wherein the controller is configured to:
send bits of the de-serialized reflection bitstream to a plurality of processing elements (PEs),
send a signal instructing an address of a block random access memory (BRAM) to be updated,
send results from the plurality of processing elements to a direct memory access (DMA) module,
clear data from the processing elements,
decode the results, and
send the decoded results to a client.

2. The reflectometer of claim 1, wherein the reflectometer is a software defined optical time-domain reflectometer (SD-OTDR).

3. The reflectometer of claim 1, further comprising a circulator coupled to the transmitter and to the receiver.

4. The reflectometer of claim 3, further comprising:
an angled physical connector (APC) coupled to the circulator; and
a fiber under test (FUT), wherein the FUT comprises a single mode optical fiber with two angled physical connector (APC) mattings coupled to the APC.

5. The reflectometer of claim 1, wherein the controller comprises:
a data processing array, wherein the data processing array includes the plurality of processing elements;
a probe controller coupled to the data processing array;
the DMA module, wherein the DMA module is coupled to the data processing array and to a memory accessible by the client; and
the BRAM, wherein the BRAM is coupled to the probe controller and the transmitter.

6. The reflectometer of claim 5, wherein the controller is further configured to:
send bits of the de-serialized reflection bitstream to the data processing array, wherein the data processing array is configured to send the bits to the PEs.

7. The reflectometer of claim 6, wherein the controller is further configured to:
send a control signal from the data processing array to the probe controller, wherein the probe controller is configured to send the signal instructing the address of the BRAM to be updated.

8. A reflectometer, comprising:
a transceiver; and
a controller coupled to the transceiver, wherein the controller is configured to:
receive a reflection bitstream;
send bits of the de-serialized reflection bitstream to a plurality of processing elements (PEs),
send a signal instructing an address of a block random access memory (BRAM) to be updated,
send results from the plurality of processing elements to a direct memory access (DMA) module,
clear data from the processing elements,
decode the results, and
send the decoded results to a client.

9. The reflectometer of claim 8, wherein the controller comprises:
a data processing array, wherein the data processing array includes the plurality of PEs;
a probe controller coupled to the data processing array;
the DMA module, wherein the DMA module is coupled to the data processing array and to a memory accessible by the client; and
the BRAM, wherein the BRAM is coupled to the probe controller and the transmitter.

10. The reflectometer of claim 9, wherein the data processing array is further configured to:
receive the bits; and
send the bits to the PEs.

11. The reflectometer of claim 10, wherein the controller is further configured to:
send a control signal from the data processing array to the probe controller, wherein the probe controller is configured to send the signal instructing the address of the BRAM to be updated.

12. A system on a chip (SoC), comprising:
a transceiver configured to de-serialize a reflection bitstream; and
a controller coupled to the transceiver, wherein the controller comprises:
a data processing array coupled to the transceiver, wherein the data processing array comprises a plurality of processing elements (PEs), and wherein the data processing array is configured to:
receive the de-serialized reflection bitstream,
receive laser control values from a client,
send the laser control values to a laser control module,
send the de-serialized reflection bitstream to the PEs, and
send results from the plurality of processing elements to a direct memory access (DMA) module;
the laser control module configured to program a laser driver based on the values; and
the direct memory access (DMA) module, wherein the DMA module is coupled to the data processing array and to a memory accessible by the client, and wherein the DMA module is configured to send the results to the memory accessible by the client.

13. The SoC of claim 12, wherein the values are configured to enable a bias of the laser and a modulation of the laser to be set.

14. The SoC of claim 12, wherein the values are further configured to enable equalization, eyecrossing, and de-emphasis of the laser.

15. The SoC of claim 12, wherein the SoC further comprises:
a plurality of circulators.

16. The SoC of claim 12, wherein the SoC further comprises:
a laser driver coupled to the laser control module.

17. The SoC of claim 16, wherein the SoC further comprises:
a distributive feedback semiconductor laser (DFB-SCL) coupled to the laser driver.

18. The SoC of claim 12, wherein the SoC further comprises:
a receiver optical sub-assembly (ROSA).

19. The SoC of claim 12, wherein the SoC further comprises:
a thermos-electric cooler controller (TEC_CTRL).

20. The SoC of claim 12, wherein the laser control module is configured to program the laser driver to adjust the frequency of a laser by varying its temperature.
